(19) United States
(12) Patent Application Publication
(10) Pub. No.: US 2010/0275517 A1
(43) Pub. Date: Nov. 4, 2010

(54) ATTACHMENT LINK FOR LOUVERS

(75) Inventor: Francisco Guillen Chico, Sax (ES)

Correspondence Address: SUGHRUE MION, PLLC, 2100 PENNSYLVANIA AVENUE, N.W., SUITE 800, WASHINGTON, DC, 20037, US

(73) Assignee: Gaviota Simbac, S.L., Sax, Allcante (ES)

(21) Appl. No.: 12/746,148

(22) PCT Filed: Dec. 4, 2007
(86) PCT No.: PCT/ES07/70200

§ 371 Date: Jul. 26, 2010

(51) Int. Cl. E06B 9/02; E06B 7/08

(52) U.S. Cl. 49/82.1

(57) ABSTRACT

The invention relates to an attachment link for louvers, used to provide a connection between the louver and the winding shaft. The attachment link according to the invention provides a mode of coupling on one or more cavities or boreholes of the shaft by means of a particular mode of expansion of mobile parts which press against the walls of the cavity or the borehole. The preferred embodiment uses floating parts which enable a rapid fixing operation by means of the rotation of two pivoting parts.

### OBJECT OF THE INVENTION

The present invention relates to an attachment link for louvers used to provide the connection between the louver and the winding shaft.

The attachment link of the present invention provides a mode of coupling on one or more cavities or boreholes of the shaft by means of a particular mode of expansion of mobile parts which press against the walls of the cavity or the borehole.

### BACKGROUND OF THE INVENTION

The first modes of winding of a louver formed by slats on the winding shaft thereof were carried out with belts which were also fastened by rudimentary coupling means.

Subsequently, linking solutions between the winding shaft and the upper slat of the louver arose, which include forms of locking which prevent lifting the louver, raising it directly instead of raising it by acting on the winding shaft. The purpose of having a locking is to prevent the fraudulent attempt to lift the louver in order to enter a private property, for example.

These forms of locking require coupling parts between special links and the winding tube.

The European patent with publication number EP684362 describes an attachment link for louvers which uses longitudinal grooves present in the tubular winding shaft.

The attachment of the link on the tube uses the longitudinal grooves by inserting L-shaped plates which allow the insertion in the direction normal to the surface of the tube and which are secured with a shift perpendicular to the first insertion movement, i.e., following the longitudinal direction of the groove.

The branch of the “L” prevents the exit. To prevent the opposite maneuver giving rise to the exit of the link, the device has a catch which, after the lateral shift, enters a borehole preventing the exit upon immobilizing any shift.

The drawback of this type of coupling is that the L-shaped plates or any element of insertion in a borehole of the tubular shaft must have a clearance allowing the insertion without obstacles.

Once the link has been inserted, this clearance remains and can favor wears and even subsequent failures.

An alternative solution described and protected by patent FR2885943 is also known, which provides an alternative coupling, slightly better than the previous one since it uses a fastening in opposition.

In this solution there is an L-shaped tab entering a borehole. The L-shaped tab has the protrusion towards an end of a borehole. The fastening in opposition at the other end is achieved with a pivoting rod having an also L-shaped termination. The rotation allowing the pivoting gives rise to the second “L” being supported with pressure against the wall when the rod moves downwards.

The pressure is maintained as a result of the fact that both “Ls” are in opposition. Nevertheless, there will always be a clearance in the direction perpendicular to the plane in which the two L-shaped tabs are located.

The present invention provides a coupling means eliminating the clearances in all the directions and resulting in a highly strong fastening.

### DESCRIPTION OF THE INVENTION

The present invention consists of a link of the type which allows connecting a louver to a shaft. This part has means for fixing ties or parts connecting the first slat of the louver which must be wound in the shaft.

The shaft has a cavity or borehole allowing the attachment elements of the link of the invention. In the preferred embodiments, a tubular shaft having boreholes, although it is enough for its to have cavities with side walls on which to exert the fixing pressure, will be used.

The cavity or borehole has side walls on which a pressure in opposition is carried out; i.e., a part exerting a pressure in a sector of side wall and another part exerting a pressure in a sector arranged in opposition.

The essence of the invention consists of an attachment link for a louver for the coupling thereof to a shaft, the winding shaft of the louver. It has already been mentioned this shaft has a cavity or a borehole. The link of the invention has at least a mobile part and an insertion part, both of which are intended to be introduced in the cavity or borehole of the shaft, providing the fastening between the link and the shaft.

Said parts verify that:
the mobile part has the capacity to shift laterally with respect to the direction of insertion in the cavity or borehole,
the insertion part has the capacity to shift according to the direction of insertion or entrance in the cavity;
   such that the entrance of the insertion part occurs adjacent to the mobile part and causes the lateral shift of the mobile part, giving rise to the expansion against the walls of the cavity or borehole of the shaft.

### DESCRIPTION OF THE DRAWINGS

The present specification is complemented with a set of drawings which illustrate the preferred and non-limiting embodiment of the invention.

FIG. 1 show a section diagram of an example of the coupling in the area in which the cavity or borehole of the shaft is located according to the essence of the invention.

FIG. 2 shows a second section diagram of a more complex alternative of the mode of coupling with the shaft.

FIGS. 3 and 4 show an embodiment of a link following the operating principle of the invention with all the components according to a partially exploded perspective view with two different positions of the link in order to be able to observe the entire assembly.

FIG. 5 is an exploded perspective view of the main parts of the same embodiment which allows distinguishing all the components.

FIGS. 6 to 9 depict the link of the same embodiment in a plan view, a longitudinal section view as well as two cross-section views; all of them in correspondence with a sequence from the initial positioning to the operative fastening position. In FIG. 9 a detail which shows the shift of the floating part has been enlarged, allowing observing the cavity in which this same floating part is housed.

FIG. 10 is a detail of the link in a perspective view and in a section view according to the same embodiment, which also shows a screwdriver as a tool in releasing the link from the tubular shaft.

### DETAILED DESCRIPTION OF THE INVENTION

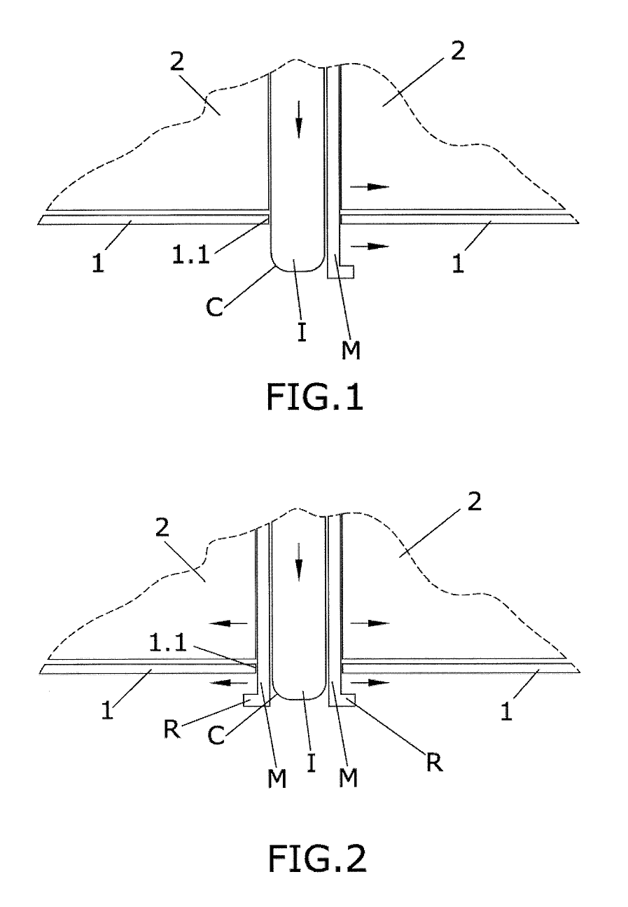

FIG. 1 shows a diagram which depicts the essence of the invention.

This diagram shows the section of a shaft (1), which is tubular in this example, having at least one borehole (1.1) in which the link (2) will be fastened. The figure only shows where the link is located since the figure only details the mode of coupling with the shaft (1).

The link (2) has at least two parts, a first mobile part (M) and an insertion part (I).

In the fastening operation, the link (2) is moved closer to the shaft (1) until being supported on the latter (1) such that the mobile part (M) enters the borehole (1.1).

This mobile part (M) has the capacity to shift laterally and can enter the borehole (1.1) without problems because the insertion part (I) is not inside the borehole (1.1) at the time of placing the link (2).

Once the link (2) has been placed on the shaft (1), supported thereon, the insertion part (I) is introduced. This insertion part (I) has dimensions such that its entrance forces the lateral shift of the mobile part (M) until both of them exert pressure against the sides of the borehole (1.1) in which they are housed. This pressure determines the fastening of the link (2) with the shaft (1).

FIGS. 1 and 2 use arrows showing the shifts which both the mobile part (M) and the insertion part (I) at least have with respect to the main body of the link (2).

The borehole (1.1) can be a cavity provided that pressure can be exerted against the side walls of the mobile part (M) and of the insertion part (I), providing the fastening.

The entrance of the insertion part (I) is facilitated if its end is rounded, for example. An advantage of the fastening of the invention is that the walls of both the mobile part (M) and the insertion part (I) which are in contact with the walls (P) of the borehole (1.1) are parallel in the area in which the definitive contact is provided, therefore there is no tendency to exit due to wedging. Another technical advantage is the absence of clearances which give rise to plays between the link (2) and the shaft (1).

FIG. 2 shows a mode of fastening which is more complex but has additional advantages. In FIG. 1), the insertion part (I) has friction with the wall of the borehole (1.1) of the shaft (1) during its entrance in said borehole (1.1).

If it is the wall of a cavity, this wall can be suitable for allowing the passage of the insertion part (I), but if it is the borehole (1.1) of a tube of sheet metal, for example, it can have sharp edges causing a locking which prevents the entrance and exit of the insertion part (I).

FIG. 2 uses two mobile parts: a first mobile part (M) and a second mobile part (M). Both mobile parts (M) also have the capacity to shift laterally; nevertheless, due to their dimensions, they are capable of entering the borehole (1.1) of the shaft (1) when the link (2) is supported on the shaft (1) in order to carry out the fastening.

After positioning the link (2), leaving the two mobile parts (M) inside the borehole (1.1), the insertion part (I) is inserted such that it is arranged between one mobile part (M) and the other.

The friction during the entrance of the insertion part (I) occurs between the walls (P) of the insertion part (I) and the mobile parts (M) since the contact between the mobile parts (M) and the wall of the borehole (1.1) of the shaft (1) does not initially require sliding. The side mobile parts (M) simply expand exerting pressure against the walls of the borehole (1.1) or the cavity, where appropriate.

Likewise, the insertion part (I) can have a rounded or beveled edge (C) facilitating the entrance. Nevertheless, the parallel side walls (P) of this insertion part (I) give rise to the formation of a sandwich without wedging with a side pressure force predetermined by the width this insertion part (I).

The end of the mobile part or parts (M) can have side flanges (R) favoring the fixing to the shaft (1) although the pressure exerted on the borehole (1.1) is not enough for a secure coupling. These flanges (R) will prevent the exit of the link (2) even in these cases of low compression.

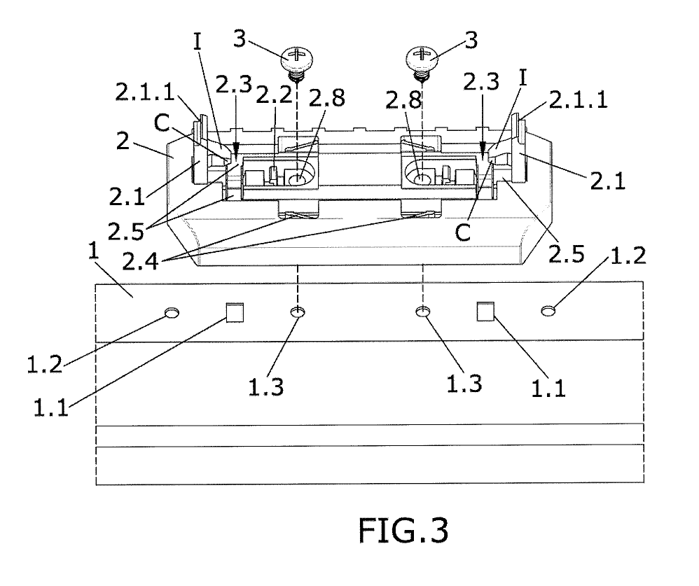

Based on FIG. 3, a more elaborate embodiment which uses two fastenings such as that described in FIG. (2) is described.

The link (2) is formed by a body, made of plastic material in this example, having a support surface adapted to the surface of the shaft (1). In this example the shaft (1) is a tubular body with a polygonal section.

In the upper surface of the main body of the link (2), the one opposite the support surface on the shaft (1), there has been arranged a group of cavities (2.10) which allow housing two floating parts (2.5) which are capable of shifting laterally.

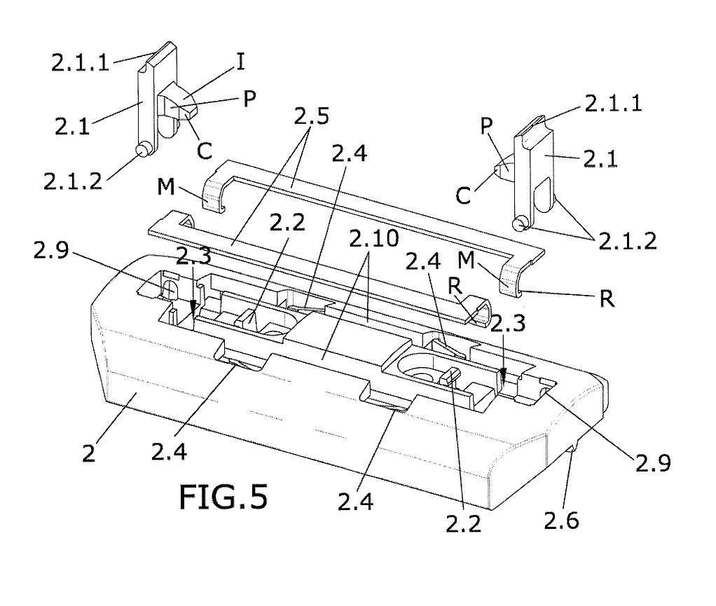

These floating parts (2.5), shown in detail in FIG. 5, are constantly pressed by springs which, in this example, have been formed like leaf springs (2.4) integrated in the main body of the link (2). The leaf springs permanently tend to bring the two floating parts (2.5) together.

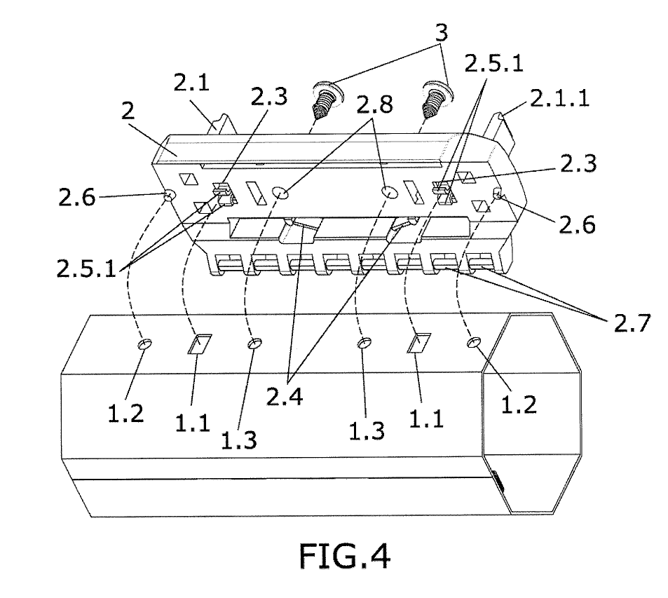

These floating parts (2.5) have at their ends downward prolongations corresponding to the mobile parts (M) described in FIG. 2. FIG. 4 shows these prolongations ending in the form of a claw (2.5.1).

In this embodiment, the floating parts (2.5) are configured by die cutting and folding sheet metal, giving rise to a part which is simple to manufacture.

The prolongations, which will hereinafter be referred to as mobile parts (M) to maintain the terminology used since the beginning, traverse the main body of the link (2) through passage cavities (2.3) such that they emerge through the lower support surface of the main body of the link (2).

In this embodiment, a floating part (2.5) has sectors corresponding to the integral mobile parts (M), each of them passes through a different passage cavity (2.3). Thus, with two floating parts (2.5) two pairs of mobile parts (M) are achieved, such that they act in twos integrally through the floating part (2.5) to which they belong.

This configuration provides a higher positional stability of the mobile parts (M), facilitates the installation inside the main body of the link (2) and the result is a more robust overall structure.

The two floating parts (2.5) tend to come together as a result of the leaf springs (2.4) and therefore the mobile parts (M) also tend to be close to one another. In this position, the entrance of the mobile parts (M) through the borehole (1.1), in which they will be housed and in which the fastening will occur, is facilitated.

FIG. 3) likewise shows the presence of two pivoting parts (2.1) which pivot along two pivots (2.1.2) which are introduced in respective housings (2.9) for the rotation located in the main body of the link (2).

Each of the pivoting parts (2.1) has a flange which is identified with the insertion part (I) and will also be referred to as such hereinafter in relation to this embodiment.

The rotation of the pivoting part (2.1) allows the penetration of the insertion part (I) in the passage cavity (2.3) through which the mobile parts (M) already pass. As shown in FIG. 3, the passage of the insertion part (I) occurs between both mobile parts (M).

The entrance of the insertion part (I) forces the separation of the mobile parts (M) which will be supported with pressure against the walls of the borehole (1.1) of the shaft (1), in which they will be definitively fastened.

The main body of the link (2) has lugs (2.6) which enter receiving boreholes (1.2) used to provide the correct positioning of the main body of the link (2) with its components with respect to the shaft (1).

This positioning gives rise to the mobile parts (M) entering the boreholes (1.1) thereof, being suitably placed.

The insertion part (I) has at its end bevels (C) which favor, at the beginning of the entrance operation, the separation of the mobile parts (M) which are forced by the leaf springs (2.4). The bevels (C) separate the mobile parts (M) until such mobile parts (M) come into contact with the walls of the borehole (1.1) of the shaft (1) and press it. The pressure will be determined by the resulting thickness of the mobile parts (M) plus the thickness of the insertion part (I).

Once the insertion part (I) has overcome the bevels (C) and has given rise to the maximum fastening pressure, the introduction of same (I) continues until the two essentially parallel walls (P) thereof are placed between the two mobile parts (M). These two essentially parallel walls (P) do not show a wedging causing a tendency to exit and therefore providing an insecure coupling.

Nevertheless, the pivoting part (2.1) has at the end opposite to where it pivots a step (2.1.1) which overcomes a retaining clip (2.2) preventing it from coming out.

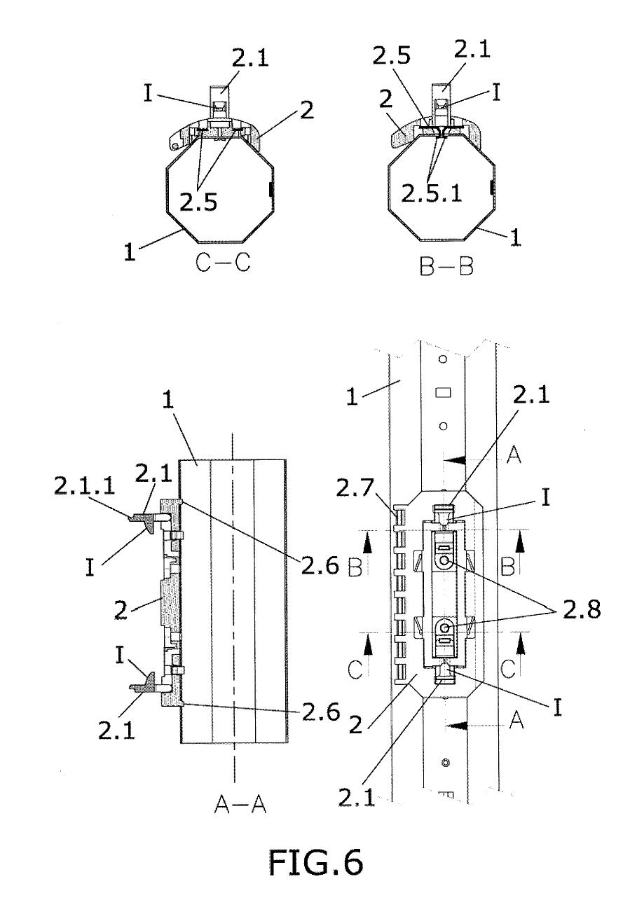

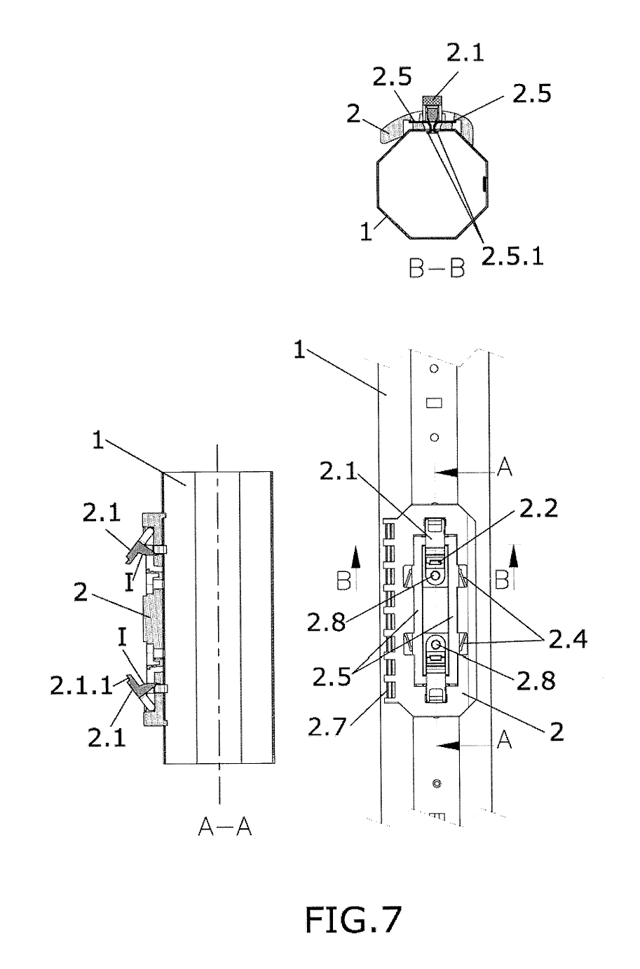

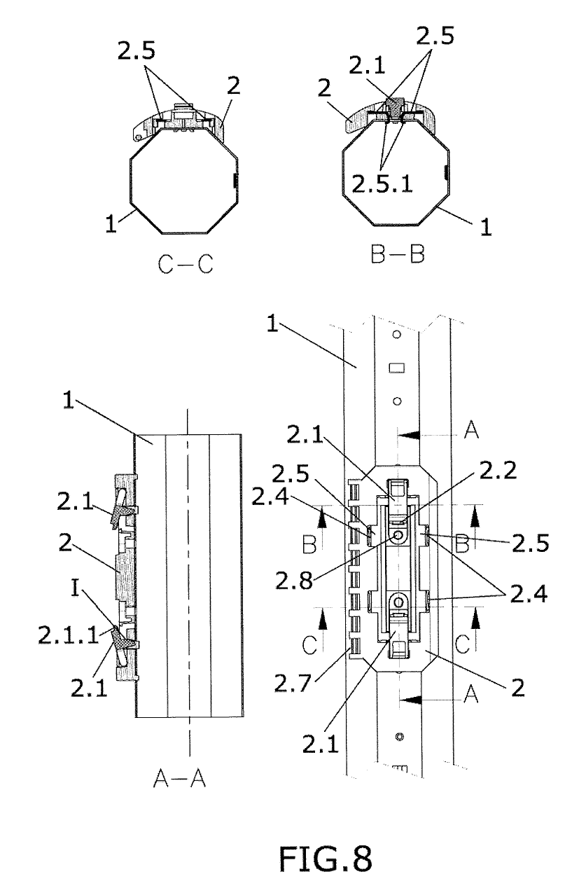

FIGS. 6 to 9 show a sequence of the closing operation in which, in addition to the elevation, the longitudinal section (A-A) allows observing the entrance positions followed by the insertion part (I).

Both the longitudinal section (A-A) and the cross-sections (B-B, C-C) have been named in an identical manner (with the letters A, B and C) for the sake of simplicity since the position of the parts having some movement changes but not the situation of the section planes. In the cross-sections (B-B, C-C) the shift of the floating parts (2.5) is distinguished since such parts (2.5) are depicted with the section completely colored instead of shaded.

FIG. 6 corresponds to the position in which the pivoting part (2.1) is completely lifted and therefore the leaf springs (2.4) are maintaining the floating parts (2.5) as close as possible.

As the insertion part (I) is introduced, the progressive separation of the floating parts (2.5) and the compression of the leaf springs (2.4) are observed in the figures of the sequence, mainly in the plan view.

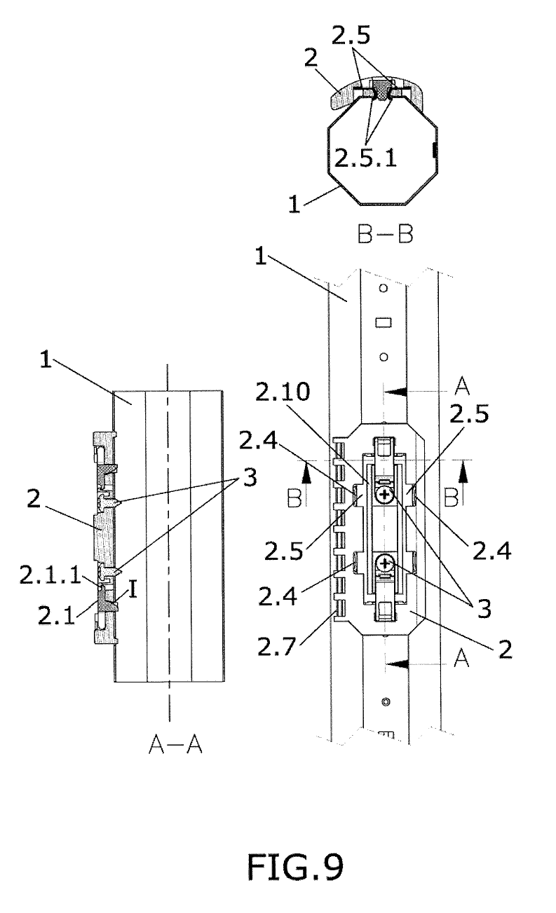

In FIG. 9, a detail has been enlarged in which a portion of the floating part (2.5) is located, showing how its shift compresses the leaf spring (2.4) and exposes the cavity (2.10) receiving the floating part (2.5).

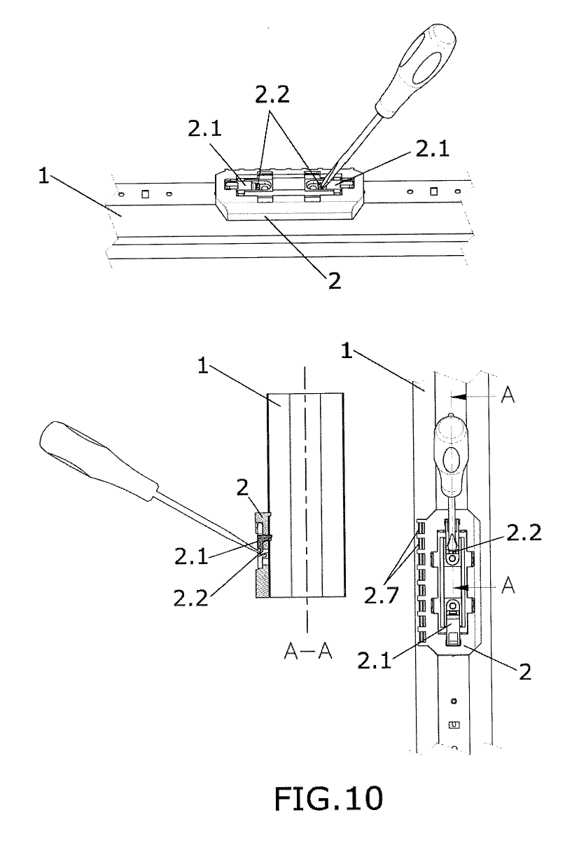

The removal of the link (2) requires carrying out the shift of the pivoting parts (2.1) in a reverse manner, in which previously, as shown in FIG. 10, it is necessary to force the retaining clip (2.2). FIG. 10 show how, with the aid of a screwdriver, it is possible to force the retaining clip (2.2) to release the pivoting part (2.1).

The leaf springs (2.4) recover the position of the floating parts (2.5), preventing the latter from being detached and falling.

The fastening, as it has been carried out, provides a coupling without clearances as a result of the sandwich formed by the mobile parts (M) and the insertion part (I), which work under compression inside the borehole (1.1).

This example uses two floating parts (2.5) giving rise to two fastening points; nevertheless, one and the same body of the link can have more fastening points or all of them connected with the same floating parts can be independent; or have more pairs of floating parts (2.5).

This embodiment likewise incorporates second boreholes (2.8) for the passage of screws (3). These screws (3) can directly reach the shaft (1) through boreholes (1.3) to form a second safety fastening.

As a constructive detail, the fixing means (2.7) for connecting the first slat which is not shown for the sake of clarity in the graphic depiction are also observed.

The result of this embodiment is a highly rapid fastening means between the shaft (1) and the first slat since, from the practical point of view, the installer only moves the link (2) closer to the shaft (1) which is positioned by the presence of the lugs (2.6); and then simply closes the pivoting parts (2.1) until the clipping occurs.

The embodiments determined by the dependent claims are considered to be included by reference in this description.

A louver closing assembly having a fixing solution such as the one described in the shaft (1) on which the louver is connected is also within the invention.

1. An attachment link for a louver for the coupling thereof to a shaft (1), in which this shaft (1) has a cavity or a borehole (1.1), characterized by having at least a mobile part (M) and an insertion part (I), both of which are intended to be introduced in the cavity or borehole (1.1) of the shaft (1), providing the fastening between the link (2) and the shaft (1), in which said parts verify that:
the mobile part (M) has the capacity to shift laterally with respect to the direction of insertion in the cavity or borehole (1.1),
the insertion part (I) has the capacity to shift according to the direction of insertion or entrance in the cavity;
such that the entrance of the insertion part (I) occurs adjacent to the mobile part (M) and causes the lateral shift of the mobile part (M), giving rise to the expansion against the walls of the cavity or borehole (1.1) of the shaft (1).

2. The attachment link for a louver according to claim 1, characterized in that the link has a second mobile part (M) also having the capacity to shift laterally such that the insertion part (I), in its operative attachment position, is interposed between the first mobile part (M) and the second mobile part (M), in which the expansion can be obtained by the separation of both mobile parts (M) due to the insertion of the insertion part (I).

3. The attachment link for a louver according to claim 1, characterized in that it more than one coupling point with the shaft (1) through boreholes (1.1) or cavities present in said shaft (1).

4. The attachment link for a louver according to claim 1, characterized in that the link (2) has floating parts (2.5) with flanges giving rise to the mobile parts (M) in the fastening.

5. The attachment link for a louver according to claim 4, characterized in that the link (2) has springs giving rise to the tendency of the floating parts (2.5) to remain close to one another.

6. The attachment link for a louver according to claim 5, characterized in that the springs are leaf springs (2.4).

7. The attachment link for a louver according to claim 6, characterized in that the leaf springs (2.4) are integrated in the main body of the link (2).

8. The attachment link for a louver according to claim 1, characterized in that the insertion part (I) is formed from a pivoting part (2.1) having a flange which forms the insertion part (I).

9. The attachment link for a louver according to claim 1, characterized in that the insertion part (I) has an end which is rounded end or with bevels (C) to facilitate its entrance.

10. The attachment link for a louver according to claim 1, characterized in that the insertion part (I) has essentially planar walls (P) which are subjected to compression in the operative position thereof.

11. The attachment link for a louver according to claim 8, characterized in that the pivoting part (2.1) has a step (2.1.1) allowing the clipping with a retaining clip (2.2).

12. The attachment link for a louver according to claim 8, characterized in that the pivoting part (2.1) has pivots (2.1.2) intended to be located in housings (2.9) of the main body of the link (2) to achieve the pivoting.

13. The attachment link for a louver according to claim 1, characterized in that the main body of the link (2) has lugs (2.6) intended to enter receiving boreholes (1.2) of the shaft (1) for the correct positioning of the link (2) with respect to said shaft (1).

14. The attachment link for a louver according to according to claim 1, characterized in that the main body of the link (2) has boreholes (2.8) for the passage of screws (3) to increase the safety of the coupling.

15. The attachment link for a louver according to according to claim 1, characterized in that the main body of the link (2) has fixing means (2.7) for connecting the first slat.

16. A closing assembly formed by a louver, a shaft (1) such that the louver and the shaft (1) are connected through a link (2) according to claim 1.
